(19) United States
(12) Patent Application Publication
(10) Pub. No.: US 2012/0053963 A1
(43) Pub. Date: Mar. 1, 2012

(54) System for Dynamically Scheduling Medical Facility Appointments

(75) Inventors: Calvin Seymour, Winnsboro, LA (US); Nigel Smedley, Winnsboro, LA (US); Eric Morris, Winnsboro, LA (US); Leigh Williams, Winnsboro, LA (US); Brandon Smith, Winnsboro, LA (US); Greg Bradley, Winnsboro, LA (US); Daniel Williams, Winnsboro, LA (US)

(73) Assignee: CADMEAN, INC., Winnsboro, LA (US)

(21) Appl. No.: 12/869,923

(22) Filed: Aug. 27, 2010

(51) Int. Cl. G06Q 10/00

(52) U.S. Cl. 705/3; 705/7.19

(57) ABSTRACT

The present invention comprises a system and method for dynamically scheduling patient medical facility appointments. The present invention is capable of contacting patients to ensure that each patient will be present for the appointment and is capable of dynamically adjusting the schedule in the event the patient plans to be late or plans to cancel the appointment. The present invention is also capable of contacting patients to reschedule appointments in the event that their medical service provider unexpectedly becomes unavailable. The system's scheduling method has the effect of increasing medical facility efficiency and standardizing medical facility wait time for the patients and thereby increasing profitability and increasing patient convenience.

### FIELD OF THE INVENTION

The present invention relates generally to patient appointment scheduling software and specifically to patient appointment scheduling software that dynamically alters the patient schedule based on medical service provider availability, patient availability, and patient priority.

### BACKGROUND OF THE INVENTION

Most medical facilities currently use a variant of a scheduling system that has been available for many years. Before the prevalence of computer software, the medical facility would divide the day into a series of time slots. The number of these available time slots was limited based on the number of medical service providers working at the medical facility and the number of hours each medical service provider was willing to work. Under this system, every patient wishing to receive care is placed in a time slot. For reasons of profitability, the medical facility tends to schedule as many patients into each day as possible. Since the limiting factor in the profitability of a medical facility is the medical service provider's time, the assumption has always been that patients should wait on medical service providers, but a medical service provider should never wait on a patient.

This mode of thinking encourages the medical facility to load the schedule as heavily as possible. One problem with this method is that patients occasionally need care quickly and can't wait for their turn in the schedule. These patients must be forced into the schedule into any open slots or more slots must be created for them. This forces medical facility personnel to work longer hours to see these patients. This problem is further exacerbated when a medical service provider is called away because of an emergency. When this happens, the medical facility gets behind schedule and continues falling behind until the medical service provider is available. All patients that were scheduled must then be taken in order, which causes long waits for both the patients that were scheduled during the emergency and patients who were scheduled later in the day. Additionally, each patient requires a variable amount of time with the medical service provider. Therefore, the allocated time slot is only an approximation and appointments that run long further force the medical facility off of schedule.

Due to the advent of software, approximately 32% of medical facilities have gone from the old paper schedule to a computerized software schedule. However, the old method of placing patients into static time slots is still almost universally employed. Some companies have attempted to leverage the possibilities granted by software to increase productivity. They use various methods to allow patients to schedule appointments online to reduce the need for personnel to accept patient calls. Other software applications allow patients to submit their personal schedules and compare those schedules to medical facility schedules in an attempt to determine the optimal time slot for the patient. Other systems even contact the patients immediately prior to their time slots to allow them to check into the system remotely. However, all of these systems use the old time slot method. That means that they each place the medical facility off of schedule and require long patient wait times when medical service providers suddenly become unavailable, when unscheduled patients come in, and when appointments last longer than a normal appointment. In addition to these inefficiencies, these systems are not designed to adjust the schedule to compensate for patient cancellations.

Therefore, what is needed is a system for dynamically scheduling medical facility appointments. The system for dynamically scheduling medical facility appointments should keep a queue of patients wanting appointments for a particular day and contact them only if a medical service provider is available to prevent long in-facility wait times. This system should also adjust based on canceled appointments and patients who fail to appear for appointments by contacting other patients in the queue. This system should also place non scheduled patients in the queue so that they can be worked into the schedule fairly and in a way that minimizes the need to burden the staff by extra long hours. This system should also be capable of altering patient appointment priority and be capable of referring and scheduling patient appointments for other networked providers. Furthermore, other desirable features and characteristics of the present invention will become apparent when this background of the invention is read in conjunction with the subsequent detailed description of the invention, appended claims, and the accompanying drawings.

### SUMMARY OF THE INVENTION

The present invention advantageously fills the aforementioned deficiencies by providing a system for dynamically scheduling medical facility appointments. The system keeps a queue of patients, contacts them to come into the facility immediately prior to their appointment and only if the medical facility is prepared to receive them, contacts other patients if a patient does not respond to a contact attempt, places nonscheduled patients in queue with scheduled patients, and fairly distributes patients throughout the day to prevent long wait times for either the medical service provider or the patient.

The present invention now will be described more fully hereinafter with reference to the accompanying drawings, which are intended to be read in conjunction with both this summary, the detailed description, and any preferred and/or particular embodiments specifically discussed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The drawings contained herein exemplify one of the embodiments of the claimed invention. The invention is not limited to the embodiment shown. The embodiment shown is purely an example, and the invention is capable of many variations of said embodiment. In the drawings,

FIG. 1 is a block diagram of hardware components and a software process used in an embodiment of the present invention;

FIG. 2 is a block diagram of hardware components used in an embodiment of the present invention;

FIG. 3 is a block diagram showing a data transfer used in an embodiment of the present invention;

FIG. 4 is a block diagram showing the information stored in the data structures used in an embodiment of the present invention;

FIG. 5 is a flow chart showing a method of initiating an appointment request in an embodiment of the present invention;

FIG. 6 is a flow chart showing a method of scheduling patient appointments in an embodiment of the present invention;

FIG. 7 is a flow chart showing a method of scheduling patient appointments when patients are unresponsive to contact attempts in an embodiment of the present invention;

FIG. 8 is a flow chart showing a method of tracking patient movement during the course of an appointment and collecting data related to appointment duration for later use in an embodiment of the present invention;

FIG. 9 is a flow chart showing a method of scheduling dependant appointments in an embodiment of the present invention;

FIG. 10 is a flow chart showing a method of dynamically rescheduling patient appointments when a medical service provider becomes unavailable in an embodiment of the present invention; and

FIG. 11 is a flow chart showing a method of referring patients between medical service providers in an embodiment of the present invention.

The first digit of each reference numeral in the above figures indicates the figure in which an element or feature is most prominently shown. The second digit indicates related elements or features, and a final letter (when used) indicates a sub-portion of an element or feature.

### DETAILED DESCRIPTION OF THE INVENTION

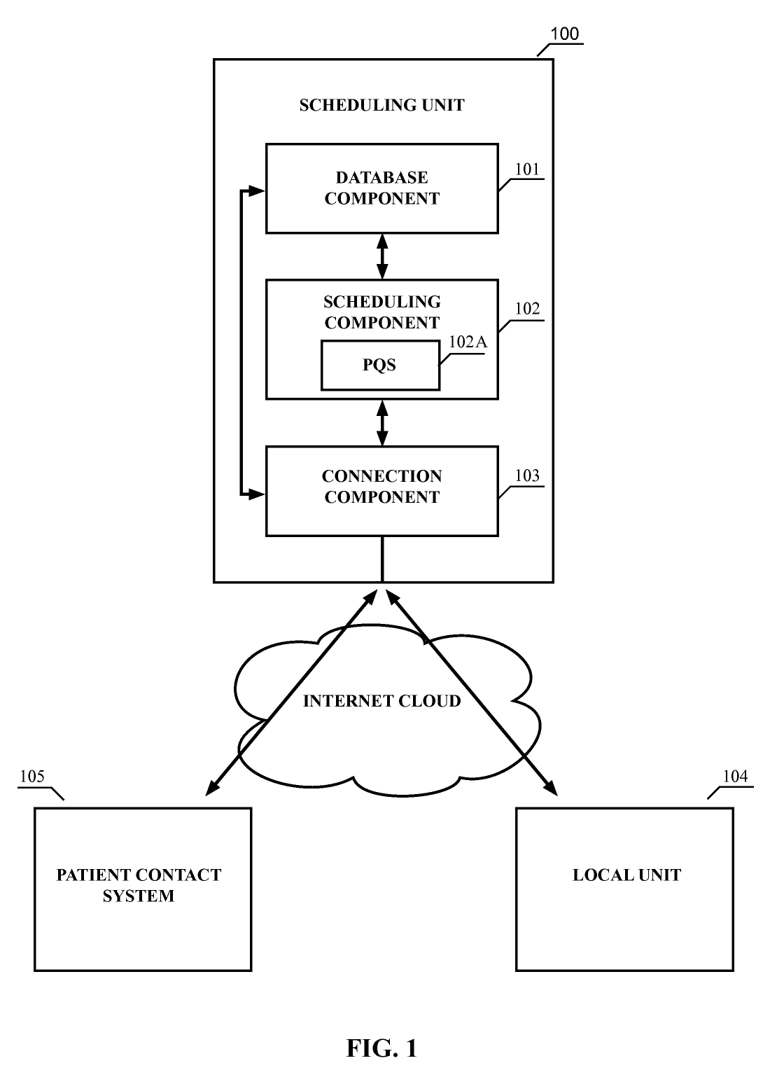

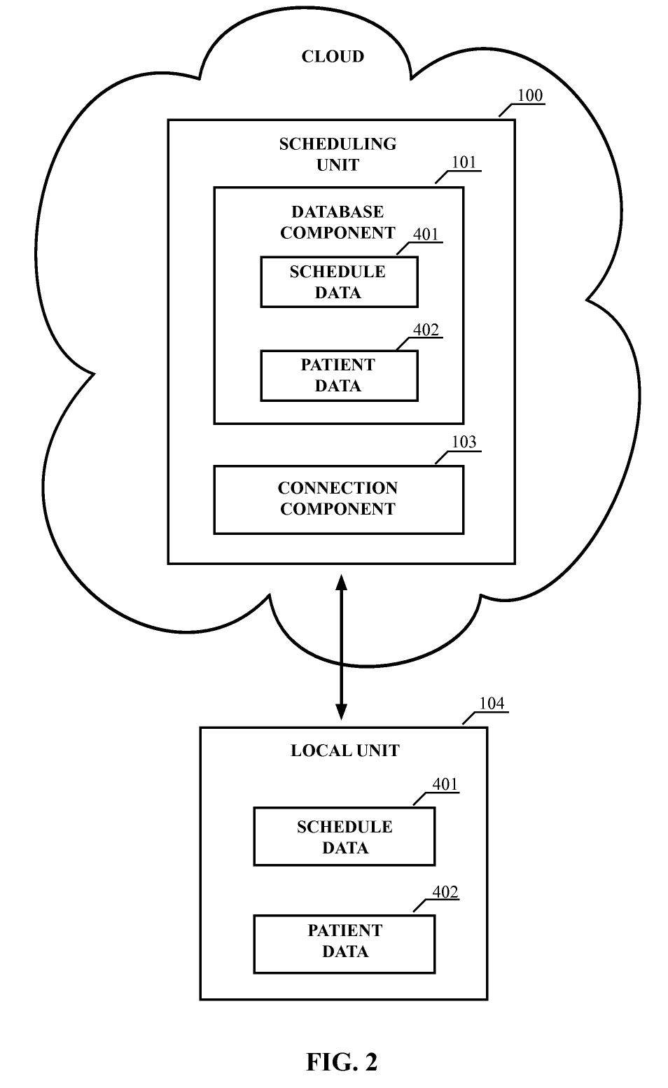

FIG. 1 is a block diagram of hardware components and a software process used in an embodiment of the present invention. The present invention comprises a scheduling unit 100 further comprising a microprocessor based computer system. In the preferred embodiment of the present invention, the scheduling unit comprises a computer server or a cloud of computer servers, as discussed in reference to FIG. 2.

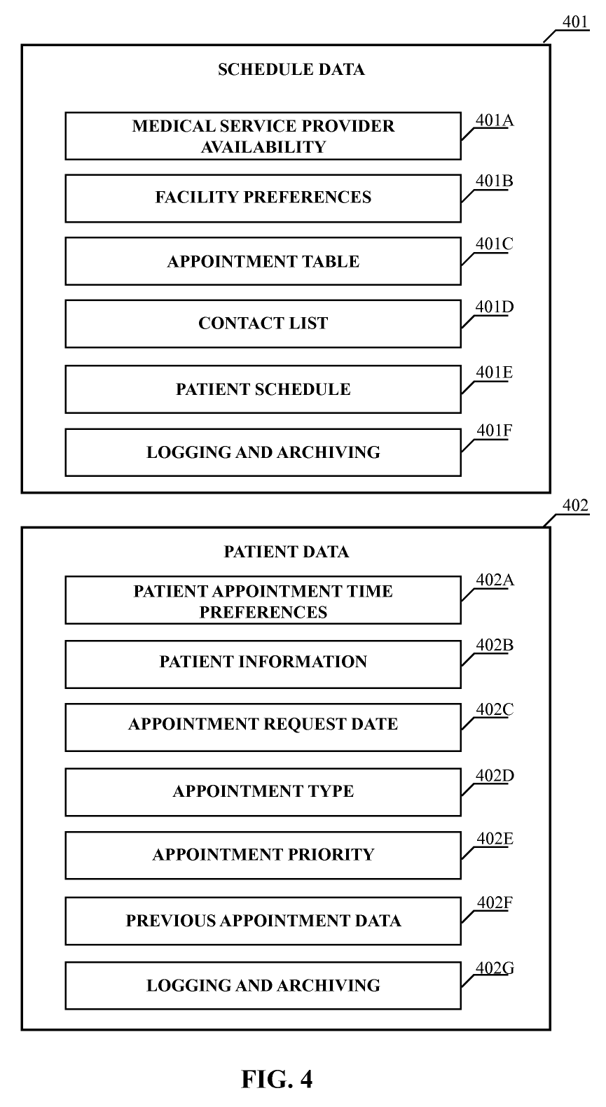

The scheduling unit 100 further comprises a database component 101. The database component 101 may be any software, firmware, or hardware device that is capable of saving and retrieving data. The database component should be configured to store schedule data 401 and patient data 402 as discussed more fully in relation to FIG. 4.

The scheduling unit 100 further comprises a connection component 103 configured to transmit and receive data. The connection component 103 may be any of a wide range of hardware, firmware, or software devices capable of transmitting data over a network or over the internet. The connection component 103 may be permanently installed into the scheduling unit 100. The connection component 103 may also comprise an external device that may be attached and removed from the scheduling unit 100. The connection component 103 may also comprise more than one device or a series of devices. The only requirement is that the connection component 103 must be capable of transmitting and receiving data from the scheduling unit 100 to other devices in the system and receiving data from those other devices.

The scheduling unit 100 further comprises a scheduling component 102. The scheduling component 102 may comprise one or a plurality of microprocessors or similar devices configured to control the general operations of the scheduling unit 100. The scheduling component 102 should be electrically connected to the connection component 103 and the database component 101 using industry standard technology. The scheduling component 102 should be configured to retrieve data from the database component 101 and send data to the connection component 103 to be forwarded to other devices outside of the scheduling unit 100. The scheduling component 102 should also be configured to receive data from the patient contact system 105, through the connection component 103 as discussed below, and alter data stored in the database component 101 based on the data received. In the preferred embodiment, the scheduling component 102 should also be configured to implement the appropriate embodiments of the methods discussed herein.

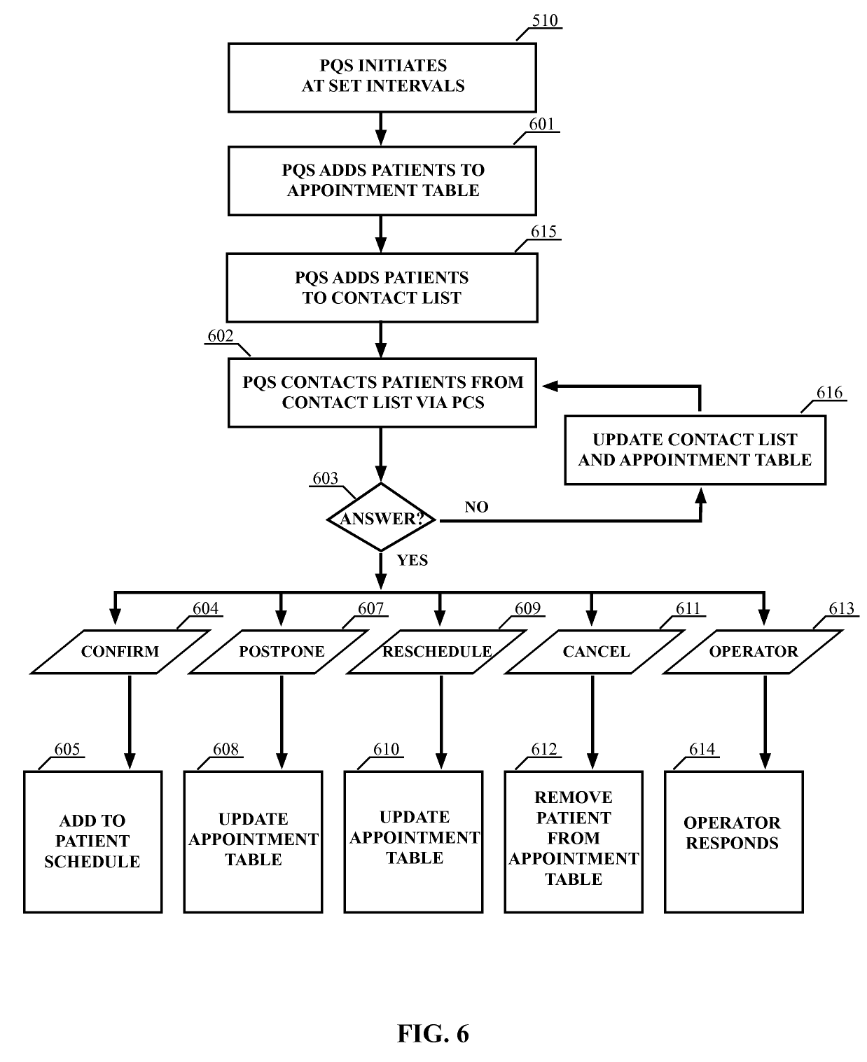

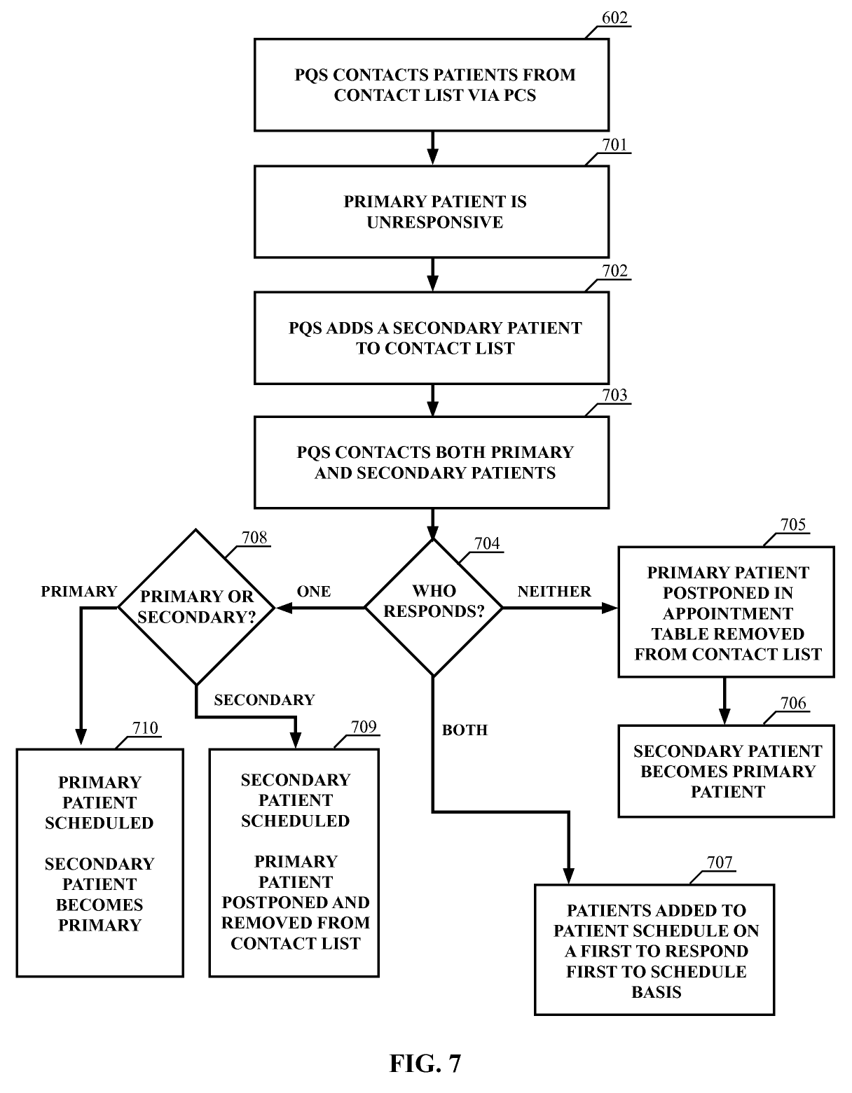

The scheduling component 102 further comprises a patient queuing system 102A. It should be noted that in the present disclosure patient queuing system 102A is sometimes referred by its acronym PQS. The patient queuing system 102A is a software process capable of initiating contact with patients through other components, adding patients to and removing patients from a medical schedule based on the patient's response, and dynamically adjusting a medical schedule based on patient behavior. The patient queuing system's 102A method of operation is discussed in more detail in relation to FIG. 6 and FIG. 7.

The present invention further comprises a patient contact system 105 capable of eliciting responses from patients. The patient contact system 105 may comprise automated computer systems employing communication lines, human operators, or medical facility employees. For the purposes of the present disclosure, patient contact system 105 is sometimes referred to by its acronym PCS. In the preferred embodiment, a medical facility has the option of employing a combination of human and automated systems to contact patients. The patient contact system 105 may contact patients by telephone, cellular phone, text message, email, or any similar technology. In the preferred embodiment, the patient contact system 105 employs a computer system that is configured to connect to the connection component 103 of the scheduling unit 100 through the internet. When human operators are employed, the human operators must have access to a system capable of connecting to the scheduling unit 100. The patient contact system 105 receives patient data from the scheduling unit 100, elicits responses to scheduling related questions, and forwards the patient responses to the scheduling unit 100. The scheduling component 100 may then alter the data in the database component 101 based on the patient responses. Any scheduling data 401 alteration should be made on a first response first scheduled basis as discussed in reference to FIG. 7 hereinbelow.

In the preferred embodiment, the present invention further comprises one or more local units 104. A local unit 104 may be any personal or office computer system typically used in a medical facility or similar setting. The local unit 104 is configured to receive input from medical service providers or their staff. The local unit 104 is also configured to transmit and receive data to and from the database component 101 of the scheduling unit 100 over the internet and through the connection component 103.

FIG. 2 is a block diagram of hardware components used in an embodiment of the present invention. FIG. 2 is intended to show that the scheduling unit 100 may comprise several servers or a cloud of servers. In this case, the database component 101 spans several different server systems. The database component 103 stores schedule data 401 and patient data 402 as discussed more fully in reference to FIG. 4. In the preferred embodiment, each local unit 104 is capable of accessing both patient data 402 and schedule data 401 relevant to the medical facility related to the particular local unit 104. These data may then be displayed for the medical facility staff. The medical facility staff may modify data stored on the local units 104 for transmission to the database component 101.

In the preferred embodiment, the local unit is capable of receiving schedule data 401 and patient data 402 as discussed more fully in relation to FIG. 4. The local units 104 are configured to receive input from medical facility personnel related to patient check in as patient data 402. The local units 104 may also be configured to track a patient's status in the medical facility during the course of their appointment and save the data as patient data 402. A patient's status may include a patient's current physical location, a patient's location in the medical facilities workflow model, or any similar status descriptor. The local units 104 may also be configured to save data related to patient appointment durations, durations between status changes, and data related to the patient's check in timeliness as patient data 402. The local units 104 may also be configured to transmit patient data related to the database component 101 of the scheduling unit 100 through the connection component 103. In the preferred embodiment, the scheduling component 102 is configured to alter schedule data 401 stored in the database component 101 on an analysis of patient data 402 and trends in patient data 402 related to a particular medical facility, particular medical service provider, particular patient, or other criteria.

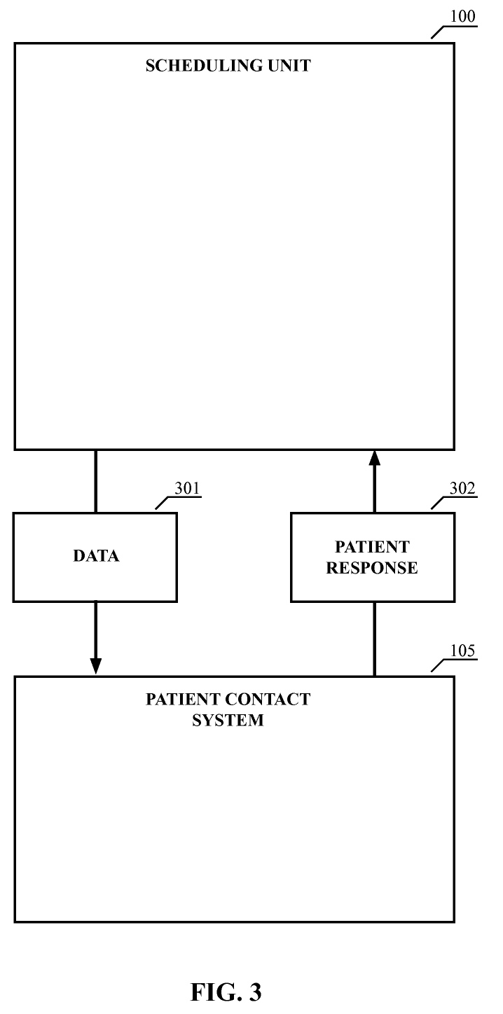

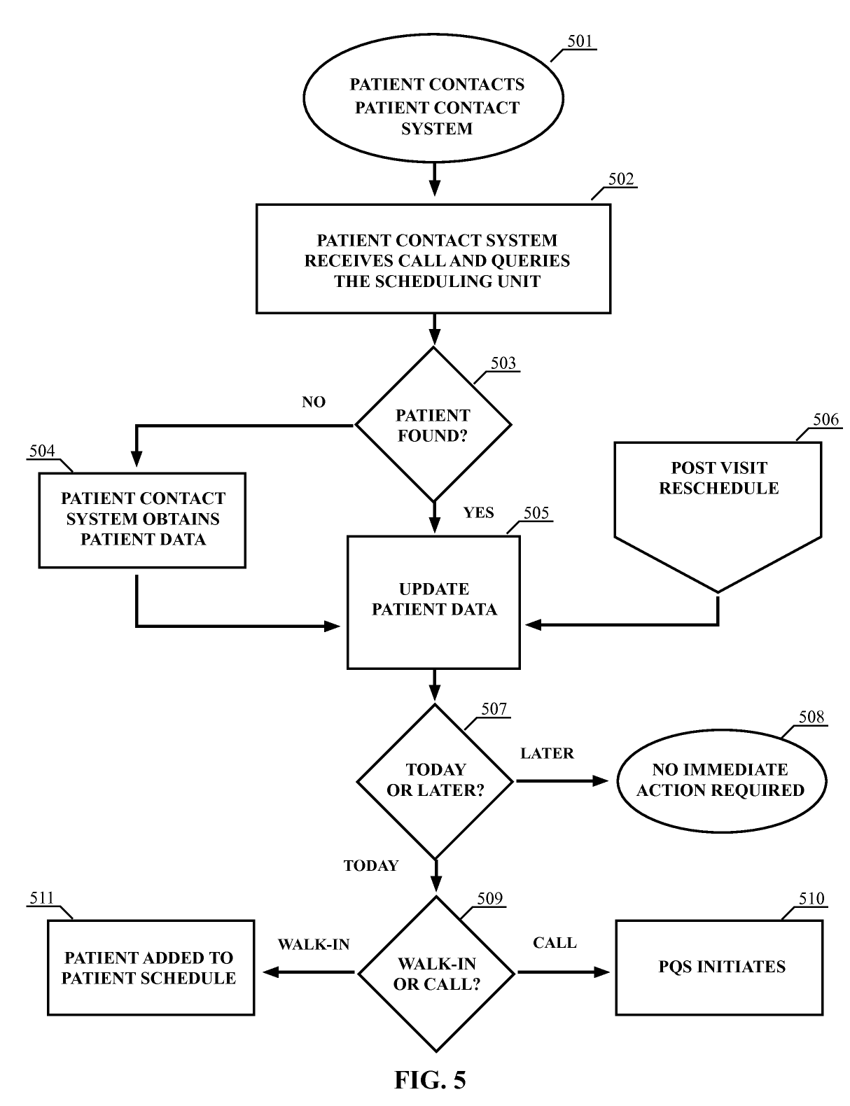

FIG. 3 is a block diagram showing the data transfer used in an embodiment of the present invention. As discussed more fully in reference to FIG. 5, FIG. 6, and FIG. 7, when the scheduling unit 100 attempts to schedule an appointment; the scheduling unit 100 forwards data 301 relating to the patient to the patient contact system 105. Any patient responses 302 received, and any failures to respond, are returned to the scheduling unit 100 for further processing.

FIG. 4 is a block diagram showing the information stored in the data structures used in an embodiment of the present invention. The database component 101 stores schedule data 401. In the preferred embodiment, the local units 104 each store schedule data 401 relevant to a particular medical facility, medical service provider, or both. The local units 104 can access relevant schedule data 401 from the database component 101, display the schedule data 401, and make changes to the schedule data 401. Depending on the embodiment, the local units 104 may have varying levels of access to schedule data 401 depending on the needs of the end users. In the preferred embodiment, the schedule data 401 comprises information related to medical service provider availability 401A. The medical service provider availability 401A data may indicate when a given medical service provider is projected to be available to see patients, whether the medical service provider is currently available, or similar data. Medical service provider availability 401A data is used for scheduling purposes. The schedule data 401 may further comprise facility preferences 401B which include information relating to particular medical facility hours and other scheduling data. This information may be used to allow medical facility staff to group similar appointment types together, require certain appointment types only occur at certain times or on certain days, or may be used for other scheduling purposes. The schedule data 401 may further comprise an appointment table 401C. As discussed below, the appointment table 401C contains data regarding pending appointments, and is created by the scheduling unit 100. The schedule data 401 may further comprise a contact list 401D. The contact list is created by the scheduling unit 100 from data in the appointment table 401C and comprises the patients to be contacted regarding a pending appointment. The schedule data 401 may further comprise a patient schedule 401E, created by the scheduling unit 100 as discussed more fully in reference to FIG. 5, FIG. 6, and FIG. 7. The schedule data 401 may further comprise logging and archiving data 401F comprising expired schedule data 401 that may be retained for future efficiency analysis or other purposes.

In the preferred embodiment, the database component 101 stores patient data 402. Depending on the embodiment, the local units 104 may store, some, all, or none of the patient data 402 relevant to a particular medical facility. The local units 104 may access, display, and change patient data 402 as needed. Depending on the embodiment, the local units 104 may have varying levels of access to patient data 402 depending on the needs of the end users. In the preferred embodiment, patient data 402 further comprises patient appointment time preferences 402A. Patient appointment time preference data may indicate the times that a patient wishes to come to the medical facility for an appointment or the times that a patient will be unavailable for an appointment, depending on the embodiment. The patient data 402 may further comprise patient information 402B, including contact information, medical history, and any other information that may be useful to a medical facility. The patient data 402 may further comprise data containing an appointment request date 402C. Patient appointment request date 402C data indicate the date or dates that a patient wishes to come to the medical facility for an appointment. The patient data 402 may further comprise an appointment type 402D. Appointment type data 402D may be used by the scheduling unit 100 in conjunction with provider preferences data 401B for scheduling purposes. The appointment type data 402D may comprise data related to the status of the patient including whether the appointment is for a routine checkup, checkup related to a specific illness, a sick patient, or an injured patient. The patient data 402 may further comprise appointment priority data 402E. The appointment priority 402E may contain data related to the urgency of the appointment including, but not limited to, whether the patient's needs are normal, heightened, urgent, or critical. In an alternate embodiment, the appointment priority 402E may contain data which includes standard patient codes. The appointment priority 402E may be used to increase or decrease the patient's position on the appointment table 401C for earlier or later scheduling based on that patient's needs. The patient data 402 may further comprise previous appointment data 402F. Previous appointment data 402F may be used for estimating the time a patient will need for an appointment for scheduling purposes. The system may track a patient's check in time, check out time, and patient's status and location in the medical facility as previous appointment data 402F. Previous appointment data 402F can be used to track the historical length of specific procedures and wait times to better predict appointment length. Previous appointment data 402F may also be retained to determine if a particular patient has a history of missing appointment or appearing late for appointment. Previous appointment data 402F may also be used by the scheduling unit 100 to predict patient behavior based on past behavior and adjust relevant schedules to minimize that patient's impact on the schedule. The patient data 402 may further comprise logging and archiving data 402G which can be used to store any other patient data that the system designer deems useful for further efficiency analysis or other purposes.

FIG. 5 is a flow chart showing a method of initiating an appointment request in an embodiment of the present invention. FIG. 5 describes both the operation of the system and the methods for scheduling appointments which are both a subject of the present invention. The flow chart begins when a patient contacts the patient contact system 501 requesting an appointment. As stated above, the patient contact system 105 may be medical facility personnel, third party operators, an automated system, or a combination of both automated and human operated systems. The patient contact system 105 receives the patient call requesting the appointment and queries the scheduling unit 502 to determine if additional patient data 402 is needed for the patient requesting the appointment. If the patient contact system is an automated system, the query and response are automatic. If the patient contact system requires human interaction, a computer system must be used to execute the query and update the information. The query is then executed to determine if the patient is found 503. If the patient's data 505 is already present in the scheduling unit 100, the system updates the patient's data based on the appointment request 505 with an appointment request date 402C, an appointment type 402D, and any changes to the patient's appointment time preferences 402A. If the patient is not found, the patient contact system 105 obtains the appropriate patient data 503, including patient information 402B, patient appointment time preferences 402A, appointment request date 402C, and appointment type 402D and then updates the patient's data based on the appointment request 505. The update may occur on the scheduling unit 100 the local unit 104 or both depending on the embodiment. In the event a patient is scheduling a new visit while at the medical facility and immediately following an appointment, known as a post visit reschedule 506, the office personal act as the patient contact system 105 and the patient's data is updated 505. It should be noted that alternate embodiments of the present invention may not require all of the preceding data to be collected or may require additional or different data. The recitation of data to be collected from the patient should not be construed as limiting.

If the patient requests that the appointment be made for a later time 507, no immediate action is required 508. If an appointment is scheduled for the same day, the scheduling unit 100 must determine if the patient called in or is present at the medical facility 509 from information obtained from the patient contact system 105. If the patient is present at the facility, the patient may be immediately added to the patient schedule 511. In an alternate embodiment, the patient may instead be added to the appointment table 401C for later addition to the patient schedule 401E. Adding the patient to the appointment table 401C increases in-facility wait time for the walk in patients, but ensures greater fairness in scheduling with the call in patients. If the patient is a call in patient, the updated patient data 505 is used by the patient queuing system 102A when it initiates 510.

FIG. 6 is a flow chart showing a method of scheduling patient appointments in an embodiment of the present invention. More specifically, FIG. 6 discloses both the system and the method for creating the patient schedule 401E based on the patients that have already requested appointments. The patient queuing system 102A initiates at intervals 510 that are set by scheduling unit 100 operators. In the preferred embodiment, the patient queuing system 102A initiates for each medical facility immediately after the end of the medical facilities office hours to prepare for the next day and periodically throughout the day to keep the patient schedule 401E filled. In the preferred embodiment, when the patient queuing system 102A initiates at the end of the medical facilities office hours, said patient queuing system 102A sends an automated appointment reminder to all patients scheduled for the next day, depending on the preferences set by the medical facility.

When the patient queuing system 102A initiates, said system saves an appointment table 401C, further comprising a list of patients requesting appointments, as schedule data 401. The patient queuing system 102A queries the patient data 402 relative to a given medical facility, returns all patients with an appointment request date 402 within a predefined range, and saves the returned patients to the appointment table 401C. In the preferred embodiment, the date range is the current date. In an alternate embodiment, the date range may be extended to the following date for reminder purposes. In the event that an appointment table already exists when the patient queuing system 102A initiates, the patient queuing system 102A saves any new patients returned by the query to the existing appointment table 401C. When creating the appointment table 401C, the patient queuing system 102A marks certain appointment times as unavailable based on provider preferences 401B, medical service provider availability 401A, and the patient schedule 401E. The patient queuing system 102A saves patients into the available times in the appointment table 401C based on each patient's appointment type 402D, patient appointment time preferences 402A, appointment priority 402E, and previous appointment data 402F.

The patient queuing system 102A saves a contact list 401D, as schedule data 401. The contact list 401D comprises patients requesting appointments. The patient queuing system 102A saves patients to the contact list 615 from the appointment table 401C. In the preferred embodiment, the contact list 615 is created immediately before patient contact attempts are undertaken by the patient contact system 105. In the preferred embodiment, the patients are contacted the day before the appointment with an approximate appointment time. The patients are then contacted again immediately prior to the appointment based on that patient's previous appointment data 402F, appointment time preferences 402A, and any imminent openings in the patient schedule 401E. The patient queuing system 102A contacts the patients on the contact list by sending a request to the patient contact system 602. The purpose of the contact immediately prior to the appointment is to request that responsive patients confirm their availability for the next available appointment time in the patient schedule 401E. The contact immediately prior to the appointment 602 is only undertaken if there is an imminent opening in the patient schedule and the appropriate medical service provider is available. In this manner, patients are not called in until the medical facility is ready to receive them. If the patient does not answer 603, the patient queuing system 102A updates the contact list and the appointment table as discussed in FIG. 7. If the patient answers 603, the patient queuing system 102A reacts to the patient's response as received from the patient contact system 105.

If the patient confirms 604 that he will be present for the appointment, the patient queuing system 102A adds the patient to the patient schedule 605 and does not consider other patients for that patient's scheduled time period. If, as a result of a contact, the patient elects to postpone 607 the appointment or reschedule 609 the appointment, the patient queuing system 102A removes the patient form the appointment table and updates the patient's appointment request date 402C as necessary, thereby postponing any further contact attempts. The patients that elected to postpone the appointment are contacted during a later cycle of the patient queuing system 102A, after a predetermined interval set by the system administrators. This process allows other patients to be called to fill the available time in the schedule left by patients that wish to postpone, reschedule, or cancel. If a patient responds by requesting an appointment be cancelled 611, the patient queuing system 102A removes the patient from the appointment table 612 and changes the patient's appointment request date 402C so that the patient will not be added back to the appointment table 401C. If the patient responds by requesting an operator 613, the patient contact system 105 sends an alert requesting that a human operator respond 614 to discuss the patient's concerns and make any appropriate schedule changes in the scheduling unit 100.

FIG. 7 is a flow chart showing a method of scheduling patient appointments when patients are unresponsive to contact attempts in an embodiment of the present invention. More specifically, FIG. 7 discloses both the system and the method for updating an appointment table and contact list 616 when a patient is unresponsive to a contact attempt. The process begins when that patient queuing system 102A contacts a patient from the contact list via the patient contact system 602. This contact occurs prior to the next available appointment time in the patient schedule. The patient queuing system 102A requests that the patient contact system contact the patient using the contact information stored in that patient's information 402B. For explanation purposes, the first patient on the contact list is considered to be the primary patient. In this case, when the patient contact system makes a contact attempt, the primary patient is unresponsive 701. The patient queuing system 102A responds by adding a secondary patient to the contact list 702 from the appointment table 401C. In alternate embodiment, additional patients may be added to the contact list as well. The patient queuing system 102A then attempts to contact both the primary and secondary patients 703, thereby attempting to contact a plurality of patients from the contact list. The patient queuing system 102A attempts to contact all patients that have been unresponsive to previous contact attempts using an alternate contact method, if available.

The patient queuing system 102A reacts based on which patients respond 704 to the contact attempts. If neither patient responds, the appointment table is updated, thereby postponing contact attempts to the unresponsive primary patient. The primary patient is also removed from the contact list 705. The secondary patient then becomes the primary patient 706. The patient queuing system 102A then treats the new primary patient as unresponsive 701. If both patients respond, they are each added to the schedule on a first to respond, first to schedule basis 707. In this manner, the patient queuing system 102A adds responsive patients to the patient schedule 401E based on the patients response, as shown in FIG. 6, and adds the responsive patients on a first to respond first to schedule basis. If only one patient responds, the patient queuing system 102A reacts based on whether the response came from the primary or secondary patient 708. If the response comes from the secondary patient, the secondary patient is added to the patient schedule and the primary patient is postponed in the appointment table, and removed from the contact list 709. If the primary patient responds, the primary patient is added to the patient schedule and the secondary patient becomes the new primary patient 710. The new primary patient is then treated as an unresponsive primary patient 701. In the preferred embodiment, the patient queuing system 102A discontinues contact attempts to patients with postponed appointments after a predetermined number of attempts. The number of attempts may be set by the system administrators. If a patient that previously failed to respond calls back at a later time, that patient is scheduled on a first to respond, first to schedule basis. In the preferred embodiment, all appointments for unresponsive patients that have not been confirmed by the end of the day are removed from the appointment table.

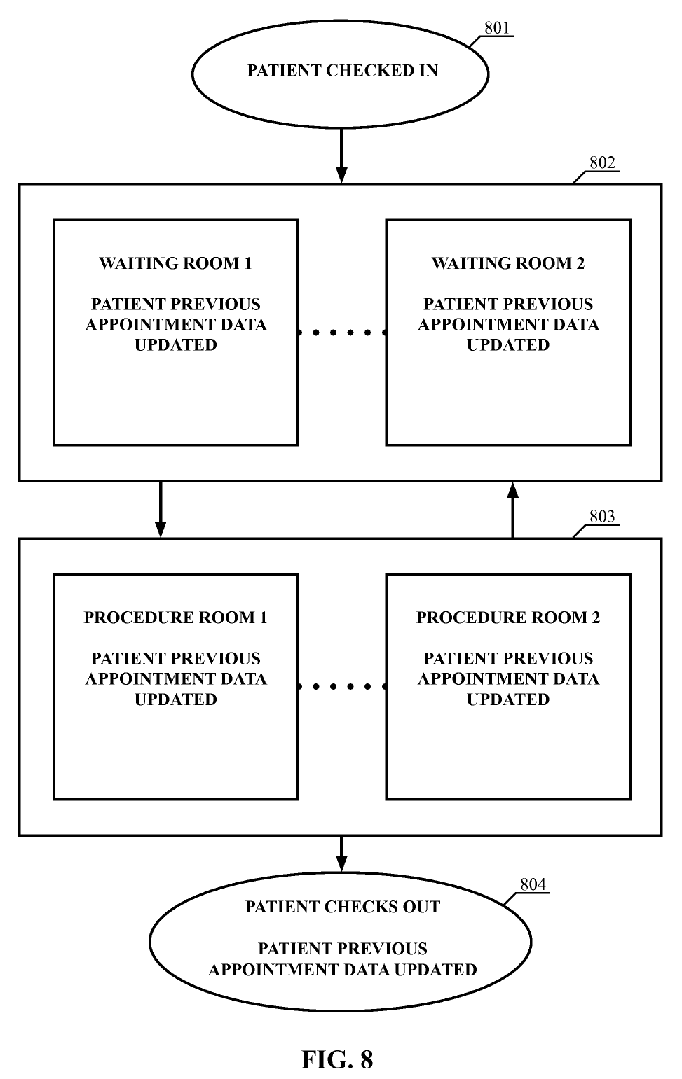

FIG. 8 is a flow chart showing a method of tracking patient movement during the course of an appointment and collecting data related to appointment duration for later use. More specifically, FIG. 8 discloses both the system and the method for tracking patient status in the medical facility during the course of the appointment and saving data related to patient appointment duration data as previous appointment data 402F. The previous appointment data 402F can be used for later scheduling purposes by the patient queuing system 102A. The previous appointment data 402F may also be retained for future use and analysis to support industry wide encounter benchmarks and to generate detailed statistical time based reports.

Upon entering the medical facility for an appointment, the patient is checked in 801. The patients check in time is saved as previous appointment data 402F, and is used as a start time to determine the patients appointment duration. Upon checking in, the patient enters a waiting room or a series of waiting rooms. In the preferred embodiment, each time the patient enters a new waiting room, the previous appointment data is updated and archived 802. The patient is then sent to a procedure room or series of procedure rooms so that relevant procedures may be performed on the patient. In the preferred embodiment, every time a patient enters a new procedure room, that patient's previous appointment data is updated and archived 803. In the preferred embodiment, every time the patient's status changes, the patient's previous appointment data is updated and archived 803. Depending on the particular medical facility and the patient's needs, a patient may move through several waiting and procedure rooms, and, in the preferred embodiment, the previous appointment data is continuously updated. Upon completing the appointment, the patient checks out and the previous appointment data is updated 804. Using this tracking method, the system has data showing how long each encounter takes and how long wait times are in various statuses on an individual basis. The previous appointment data 402F can then be used on an individual basis to estimate appointment times for scheduling purposes. The patient queuing system 102A can then more accurately predict future appointment duration times for that patient based on previous appointment duration times and schedule more or less time accordingly. As a particular patient undergoes more appointments, the increased data allows the patient queuing system 102A to more accurately predict a given patients appointment duration. The patient queuing system 102A can also create average previous appointment data 402F for patients associated with a given medical facility. This data can be made available to the facility for efficiency analysis and be used for staff or patient scheduling purposes.

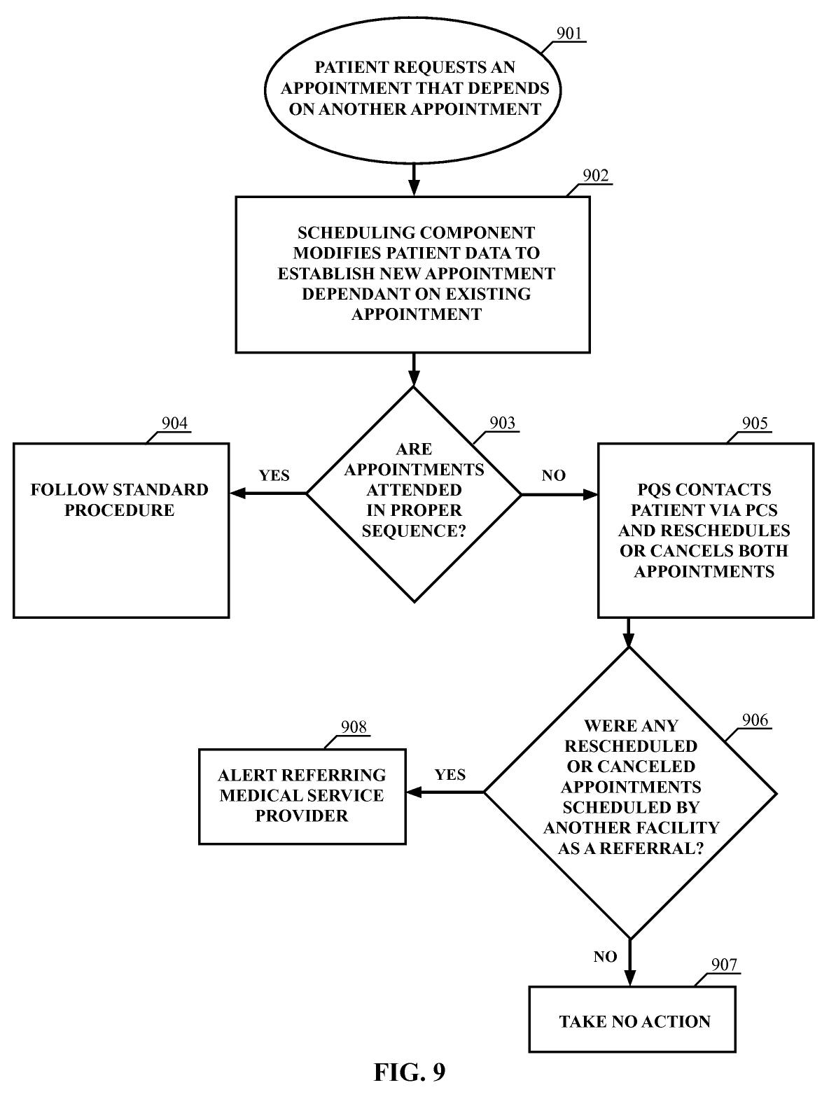

FIG. 9 is a flow chart showing a method of scheduling dependant appointments in an embodiment of the present invention. A patient may request an appointment that depends on another appointment 901. This occurs when a patient needs two or more appointments that must be completed in sequence. The scheduling component 102 modifies the patient's patient data 402 to establish the new appointment or appointments and establish their dependency upon each other or upon any appointments that have already been established 902. In an alternate embodiment, some or all of the dependant appointments may be immediately included in the patient schedule 401E.

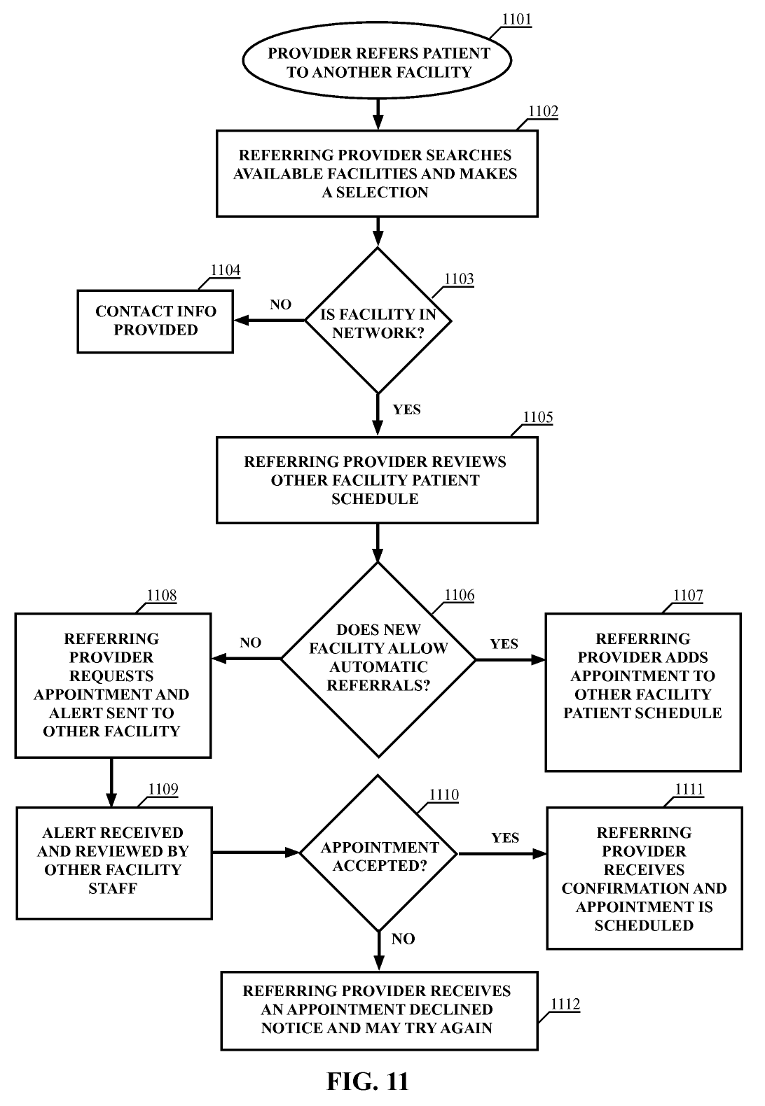

At a predetermined interval, the patient queuing system 102A checks all appointments with dependant appointments to determine if the patient attended or missed any previous appointment in the scheduled sequence 903. If the patient attended the appointment, then no action is necessary and the PQS may follow standard procedure 904. If the patient did not attend an appointment with a dependency, the patient queuing system 102A contacts the patient using the patient contact system and either reschedules or cancels both appointments based on the users input 905. The PQS then checks to determine if any of the rescheduled or canceled appointments were scheduled by another facility 906 using the referral system discussed in relation to FIG. 11. If the rescheduled or cancelled appointments were scheduled by another office, an alert is sent to the referring medical service provider 908. If the appointments were not established by a referral, then no further action is necessary 907.

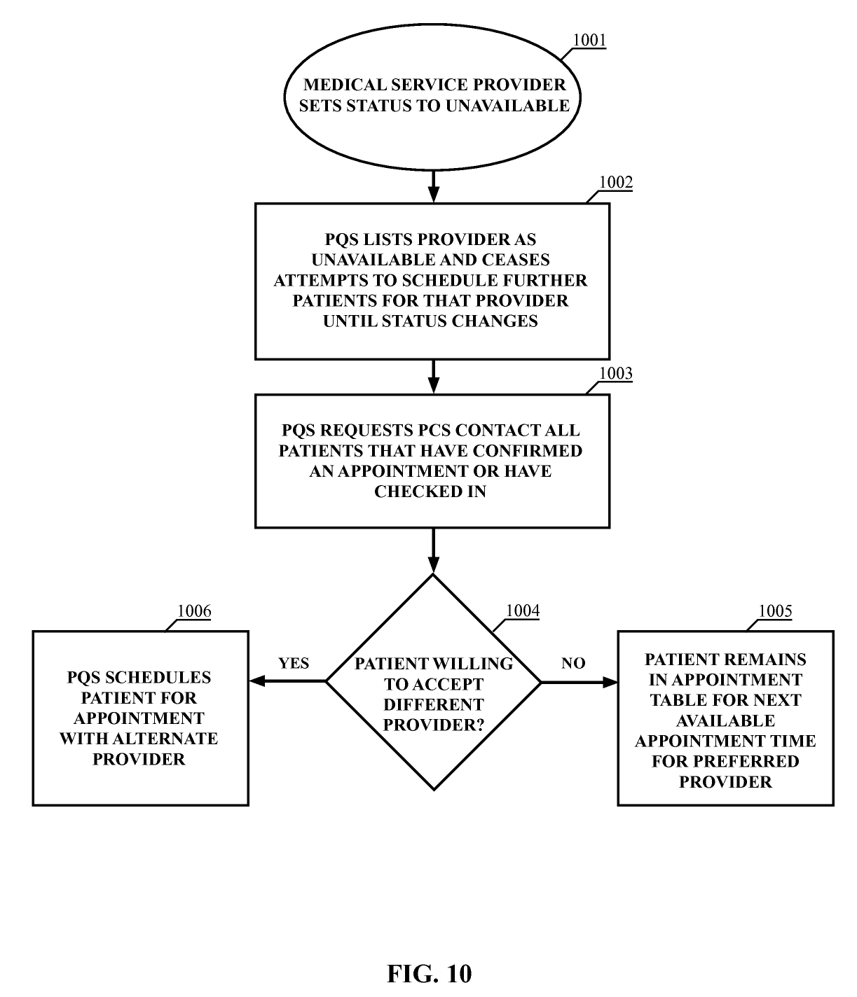

FIG. 10 is a flow chart showing a method of dynamically rescheduling patient appointments when a medical service provider becomes unavailable in an embodiment of the present invention. In the medical industry, it is common for medical service providers to become involved in emergency care that prevents them from being available for scheduled appointments. In the preferred embodiment, the patient queuing system 102A is designed to react to these common situations and dynamically schedule appointments to minimize patient wait time until normal workflow can be restored. The medical service provider may initiate the feature by setting his or her status to unavailable using a local unit 1001. The patient queuing system 102A recognizes the unavailability of the medical service provider and ceases any attempts to contact further patients and dynamically schedule further appointments for that provider until his or her status changes 1002.

The patient queuing system 102A then uses the patient contact system 105 to contact all patients that have already confirmed that they will be present for an appointment or have already checked into the facility 1003. The patients contacted in this manner are then given the option of accepting a different medical service provider or waiting on their preferred medical service provider 1004. If the patient decides to wait for the preferred medical service provider, the patient's data remains in the appointment table for the next available appointment time for the preferred provider 1005. The next appointment may or may not be on the same service date. If the patient is willing to accept an alternate provider, the patient queuing system 102A dynamically schedules the patient for an appointment with the alternate provider 1006 using the process discussed in FIG. 6.

FIG. 11 is a flow chart showing a method of referring patients between medical service providers in an embodiment of the present invention. In an embodiment of the present invention, a medical service provider needs to refer a patient to another medical facility 1101. The medical service provider interfaces with the present invention, performs a search for other facilities and providers available on the system that offer the required services, and selects an appropriate facility and provider 1102. The system must then determine if the selected medical facility participates in the system by maintaining a local unit 104 on the network of the present invention. If the selected medical facility is not in network 1103, the contact information of that facility is provided to the referring medical service provider. If the selected medical facility is in network 1103, the system provides a copy of the selected facilities patient schedule 401E for review 1105.

The preferred embodiment of the system then checks the facilities preferences 401B to determine if the selected medical facility allows automatic referrals 1106. If automatic referrals are permitted by the selected facility, the referring provider may add an appointment for the patient directly to the other facilities patient schedule 1107. If automatic referrals are not permitted, the referring provider may request an appointment for the patient by sending an alert to the selected facility 1108. The alert is then received and reviewed by the selected facility's staff 1109. If the selected medical facility accepts the appointment 1110, the system provides a confirmation to the referring provider and the appointment is added to that facility's patient schedule 1111. If the selected medical facility does not accept the appointment 1110, the system sends a notice to the referring provider that the appointment has been declined 1112. The referring provider may then select another medical facility and try again.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A system for dynamically scheduling medical facility appointments between medical service providers and patients, comprising:
a patient contact system capable of eliciting responses from patients; and
a scheduling unit, comprising a microprocessor based computer system, and further comprising,
a database component configured to store schedule data and patient data, said patient data including patient appointment time preferences;
a connection component configured to transmit and receive data to and from the patient contact system; and
a scheduling component, electrically connected to the connection component and the database component by industry standard technology, and further comprising a patient queuing system software process configured to communicate data from the database component to a patient contact system, through the connection component, further configured to receive patient responses from the patient contact system, through the connection component, and further configured to alter data stored in the database component based on patient responses, schedule data alteration being made on a first to respond first to scheduled basis.

2. The system of claim 1, further comprising: one or more local units, each comprising a microprocessor based computer system, configured to receive input from medical service providers or medical service providers staff, and configured to transmit and receive schedule data to and from the database component of the scheduling unit through the connection component of said scheduling unit.

3. The system of claim 2, wherein the patient queuing system is configured to receive schedule data showing medical service provider availability from the local units, respond by requesting that the patient contact system contact affected patients regarding their medical facility appointment times, and alter schedule data based on patient responses received from the contact system.

4. The system of claim 2, wherein the local units are configured to display schedule data received from the scheduling unit.

5. The system of claim 4, wherein the local units are configured to receive input related to patient check in.

6. The system of claim 5, wherein the local units are configured to track the patient's status in the medical facility during the course of the appointment.

7. The system of claim 6, wherein the local units are configured to save patient data related to patient appointment duration and check in timeliness as previous appointment data.

8. The system of claim 7, wherein the local units are configured to transmit patient data related to patient appointment duration and check in timeliness to the database component through the connection component.

9. The system of claim 1, wherein patient appointment time preferences, patient information, appointment type, previous appointment data, appointment request date, and appointment priority are saved as patient data.

10. The system of claim 1, wherein medical service provider availability, facility preferences, patient schedule, contact list, and appointment tables are saved as schedule data.

11. The system of claim 1, wherein the patient data is capable of comprising dependant appointments.

12. The system of claim 11, wherein the patient queuing system is configured to reschedule dependant appointments that are not attended in proper sequence.

13. The system of claim 1, wherein the patient queuing system is configured to cease eliciting responses from patients, though the patient contact system, when a related medical service provider becomes unavailable.

14. The system of claim 2, wherein the scheduling unit is configured to allow a medical service provider from one medical facility alter schedule data for another medical facility for referral purposes.

15. A method of dynamically scheduling medical facility appointments between medical service providers and patients, comprising:
receiving patient calls requesting an appointment;
updating patient data based on appointment request;
saving an appointment table, further comprising a list of patients requesting appointments, as schedule data;
saving a contact list as schedule data, said contact list comprising a list of patients requesting appointments and based on the appointment table;
attempting to contact a plurality of patients from the contact list prior to the next available appointment time in the patient schedule;
requesting that responsive patients confirm availability for the next available appointment time in the patient schedule;
adding responsive patients to a patient schedule based on patient response on a first to respond first to schedule basis; and
updating the appointment table based on patient response and thereby postponing contact attempts for unresponsive patients and patients requesting postponement.

16. The method of claim 15, further comprising, adjusting schedule data based on changes in medical service provider availability and attempting to contact affected patients regarded their appointment times.

17. The method of claim 15, further comprising attempting to contact unresponsive patients using an alternate contact method.

18. The method of claim 17, further comprising contacting patients with postponed appointments after predetermined interval.

19. The method of claim 18, further comprising discontinuing contact attempts to patients with postponed appointments after a predetermined number of attempts.

20. The method of claim 15, further comprising tracking patient status in the medical facility during the course of the appointment and saving appointment duration data.

21. The method of claim 20, further comprising saving data related to patient appointment duration as patient data.

22. The method of claim 21, further comprising predicting future patient appointment duration times based on previous appointment duration times and scheduling accordingly.

23. The method of claim 21, further comprising using data related to patient appointment duration to create industry wide encounter benchmarks and to generate detailed statistical time based reports.

24. The method of claim 15, further comprising allowing patients to schedule dependent appointments and contacting patients to reschedule said dependant appointments if the appointments are not attended in sequence.

25. The method of claim 15, further comprising allowing a medical service provider from one medical facility to alter the schedule data of another medical facility for referral purposes.

26. A computer program product, comprising a computer usable medium having a computer readable program code embodied therein, said computer readable program code adapted to be executed to implement a method for dynamically scheduling medical facility appointments between medical service providers and patients, said method comprising:
receiving patient calls requesting an appointment;
updating patient data based on appointment request;
saving an appointment table, further comprising a list of patients requesting appointments, as schedule data;
saving a contact list as schedule data, said contact list comprising a list of patients requesting appointments and based on the appointment table;
attempting to contact a plurality of patients from the contact list prior to the next available appointment time in the patient schedule;
requesting that responsive patients confirm availability for the next available appointment time in the patient schedule;
adding responsive patients to the patient schedule, based on patients response, on a first to respond first to schedule basis;
updating the appointment table based on patient response and thereby postponing contact attempts for unresponsive patients and patients requesting postponement;
adjusting schedule data based on changes in medical service provider availability;
saving data related to patient appointment duration as patient data;
predicting future patient appointment duration times based on previous appointment duration times and scheduling accordingly;
allowing patients to schedule dependent appointments and contacting patients to reschedule said dependant appointments if the appointments are not attended in sequence; and
allowing a medical service provider from one medical facility to alter the schedule data for another medical facility for referral purposes.
